(19) United States
(12) Patent Application Publication
(10) Pub. No.: US 2013/0276570 A1
(43) Pub. Date: Oct. 24, 2013

(54) FLEXIBLE TRANSMISSION DEVICE COMPRISING RIGID ELEMENT FOR RIGIDIFYING ALONG A FIRST DIRECTION AND NOT ALONG A SECOND DIRECTION

(71) Applicant: RIBOULEAU MONOSEM, Largeasse (FR)

(72) Inventor: Caroline Bergere, Bressuire (FR)

(21) Appl. No.: 13/869,556

(22) Filed: Apr. 24, 2013

(30) Foreign Application Priority Data
Apr. 24, 2012 (FR) 1253748

(51) Int. Cl. F16C 1/20

(52) U.S. Cl. CPC F16C 1/20
USPC 74/502.5

(57) ABSTRACT

A flexible transmission device is provided, which includes a guiding sheath housing a transmission cable. The device includes such a device comprises a rigid element which limits deformation of the sheath along a first direction perpendicular to the longitudinal axis of the sheath without preventing its deformation along a second direction that is essentially orthogonal to the first direction and to the longitudinal axis. The rigid element being fixedly attached to the sheath.

### CROSS-REFERENCE TO RELATED APPLICATIONS

None.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the invention is that of the designing and making of farm implements to be used for distributing products such as seed or fertilizer over a cultivable surface.

More specifically, the invention pertains to a flexible transmission device that can be used to activate the distribution means used in such implements.

### BACKGROUND OF THE DISCLOSURE

Farmers conventionally use farming implements to seed their cultivable surfaces. These implements include planters used to distribute seed as well as fertilizing units used to distribute fertilizers.

The planters and the fertilizing units comprise means for distributing respectively seed and fertilizer. These distributing means generally comprise a fixed element within which a distribution element is mounted so as to be mobile in rotation. The rotating of the distribution element within the fixed element enables seed or fertilizer to be distributed from their storage area, such as a reservoir or a hopper, up to the surface to be cultivated.

The distribution element is conventionally put into motion by means of a driveshaft connected to the distribution element by a transmission. The driveshaft is itself driven rotationally through the movement of the planter or fertilizing unit on the ground. In particular cases, the distribution element could be put into motion by means of a hydraulic motor or an electrical motor.

The transmission between the driveshaft and the distribution element is most usually achieved by means of a chain. In this case, the driveshaft bears a first pinion and the distribution element bears a second pinion, with the chain engaging these two pinions.

A chain-based transmission system of this type has the advantage of providing for a precise and effective activation of the distribution means in a simple way and of thus achieving a satisfactory distribution of seed and/or fertilizer.

However, during the performance of a seeding operation and/or fertilizer spreading operation, the chains with which the planters and/or fertilizing units are equipped can suffer weather vagaries and be subjected to sprinkling of earth and plant debris despite the use of casings to protect them. These phenomena tend to accelerate the deterioration of these chains and/or to give rise to chain derailment.

These chains also need to be regularly lubricated in order to keep them in operational condition.

As a consequence, the use of a chain to ensure transmission between the driveshaft and the distribution means implies the regular performance of maintenance campaigns.

In order to limit these maintenance campaigns, other types of transmission are implemented. In particular, the link between the driveshaft and the distribution means can be achieved by means of a flexible transmission.

Thus, as shown in FIG. 1, a flexible transmission 1 classically comprises a guiding sheath 10 within which there is mounted a transmission cable (not shown). Each end of the transmission cable is respectively linked to a transmission input 11 and to a transmission output 12 by means of an angle gear 13. The input 11 of the transmission is connected to a driveshaft and the output 12 is connected to the distribution element. Thus, the rotational movement of the driveshaft which drives the input 11 is transmitted through the transmission cable and the angle gear 13 to the output 12 which rotationally drives the distribution element.

FIG. 2 illustrates a planting element comprising a flexible transmission of this type. Thus, as shown in FIG. 2, a planting element 2 of this kind comprises a first planting element part 21 and a second planting element part 22. The first planting element part 21 is meant to be fixedly attached to a frame to form a planter. A planter generally comprises several planting elements fixedly attached side-by-side to the frame. The frame is itself fixed to a farming machine such as for example a tractor. The first planting element part 21 and second planting element part 22 are fixedly attached to each other by means of two pairs of rods 23 defining, with the first planting element part 21 and the second planting element part 22, two hinged, deformable parallelograms. The planting element rests on the ground by means of two gauge wheels 26 between which a pair of disk openers 25 is placed. The disks openers 25 are used to cut out a furrow in the earth when the planting element is shifted on the ground. The position of the gauge wheels 26 enables the depth of the furrow to be adjusted. The second planting element part 22 supports a seed storage reservoir 24, the outlet of which is connected to a seed distributor 20. The distribution element of the distributor 20 is connected to the output 12 of the flexible link. The input 11 is to be fixedly attached to drive means fixedly attached to the frame. A rotation of these drive means rotationally drives the distribution element and can thus enable the seeds contained in the reservoir 24 to be distributed in the furrow which the disk openers 25 have previously opened out on the cultivable surface on which the planting element 2 is moved. A rear block 27, comprising two wheels placed side-by-side with one another, is used to close up the furrow after the seeds have been deposited therein.

The transmission cable of such a flexible transmission is protected within the guiding sheath 10 against the sprinkling of earth, plant debris and water. Such a flexible transmission thus especially has the advantage of long service life, at least when compared to classic chain-pinion transmissions. This also limits the operations of lubrication needed to keep the transmission in good working condition. The maintenance campaigns can thus be spaced out. Furthermore, a flexible transmission does not entail any risks of derailment.

The implementing of such a flexible transmission nevertheless has a few drawbacks. When the planter is shifted on the ground, the planting element or elements 2 follow its surface. The second planting element part 22 then pivots relative to the hinges 28 while the rods 23 pivot relative to the hinges 29, the first part of the planting element 21 being fixedly attached to a frame fixed to the tractor.

During these shifting movements, the distance between the input 11 and the output 12 of the transmission 1 varies. The guiding sheath 10 is then long enough to enable the planting element to follow the profile of the ground. The sheath then tends to get deformed in every direction.

The deformations of the sheath 10 in an essentially vertical plane do not cause any problems since the distance between the rods 23 is great enough to prevent the sheath from rubbing against them.

The situation is different for its shifting motions in an essentially horizontal plane. Indeed, auxiliary apparatuses, not shown, are generally mounted on either side of the rods 23. These are, for example gearboxes, springs, wheel blocks capable of carrying the planter or any other implements. The sheath can thus rub against these implements. This tends to accelerate its wear and tear, which has an effect on the cost of maintenance of the transmission and, by extension, that of the planter.

### SUMMARY

An embodiment of the present disclosure relates to a flexible transmission device comprising a guiding sheath housing a transmission cable.

According to an embodiment of the invention, a device of this kind comprises means for rigidifying, to limit the deformation of said sheath along a first direction perpendicular to the longitudinal axis of said sheath without preventing its deformation along a second direction that is essentially orthogonal to said first direction and to said longitudinal axis, the means for rigidifying being fixedly attached to the sheath.

Thus, an embodiment of the invention relies on a wholly original approach which consists in implementing means to rigidify the sheath of a flexible transmission along a first direction perpendicular to its longitudinal axis or not flexible, or at least less flexible, along a second direction perpendicular to the first direction and to this axis. Thus, when the sheath of a flexible transmission gets deformed because of a variation in the distance between its ends, its movements are fully controlled, the sheath tending to get deformed more around the first direction, i.e. along the second direction, than around the second direction, i.e. along the first direction.

When a transmission device according to the invention is fixedly attached to a planting element such as the one shown in FIG. 2, and if we consider that the first direction extends essentially horizontally and that the second direction extends essentially vertically, the deformation of the sheath will be permitted along the arrow A and prevented along the arrows B. Thus, this sheath will be prevented from rubbing against elements mounted on either side of the sheath. The service life of the transmission is thus increased.

According to an advantageous embodiment, said means to limit the deformation comprise at least one element for rigidifying which extends along at least one part of said sheath along its longitudinal axis, the quadratic moment of said element for rigidifying relative to said first direction being smaller than its quadratic moment relative to said second direction.

The bending resistance of the element for rigidifying with respect to the first direction is therefore smaller than it is with respect to the second direction. Thus, the deformation of the sheath is encouraged along the second direction D2 (arrow A), i.e. in the plane passing through the second direction D2 and the longitudinal axis of the sheath, whereas it is limited to a greater extent along the first direction D1 (arrow B), i.e. in the plane passing through the longitudinal axis of the sheath and through the first direction D1.

Preferably, said element for rigidifying has an essentially rectangular section.

The implementing of an element for rigidifying with such a section gives the desired result in terms of control over the directions of deformation of the sheath. Other appropriate sections, for example ovoid sections, could be implemented as alternatives.

In one variant, said element for rigidifying is made out of a metallic material.

In this case, said element for rigidifying will comprise for example at least one flat iron.

The flat irons are simple to implement while at the same time being inexpensive and offering good results.

In another variant, said element for rigidifying is made out of plastic and/or composite material.

It could for example be a carbon-fiber-charged composite material.

Said element for rigidifying could be fixedly attached to said sheath by being clipped on.

In one variant, said sheath is over-molded around said element for rigidifying.

The invention also pertains to means for rigidifying for a transmission device according to any one of the variants explained here above.

The invention also pertains to a farming implement comprising:

a transmission device according to an one of the variants explained here above;

a first element to be fixedly attached to a farming machine, and a second element carrying means for distributing a product that are to be driven in motion by said transmission device, said first and second elements being linked to each other by means of rods forming, with said elements, at least one parallelogram hinged so that said second element is mobile relative to said first element in a plane passing through said longitudinal axis and said second direction,

one end of said sheath being connected to said means of distribution, its other end being fixedly attached to said first element and being meant to be fixedly attached to said driving means.

### BRIEF DESCRIPTION OF THE DRAWINGS

Other features and advantages of the invention shall appear more clearly from the following description of a preferred embodiment, given by way of a simple illustratory and non-restrictive example and from the appended drawings, of which:

FIG. 1 illustrates a side view of a flexible transmission device according to the prior art;

FIG. 2 illustrates a side view of a planting element comprising a transmission device illustrated in FIG. 1;

FIG. 3 illustrates a side view of a flexible transmission device according to the invention;

FIG. 4 illustrates a side view of a planting element comprising a transmission device illustrated in FIG. 3;

FIGS. 5 to 8 illustrate cross-sections of flexible transmission devices according to different embodiments of the invention;

FIG. 9 illustrates a partial view in perspective of an element for rigidifying a flexible transmission device according to the invention;

FIG. 10 illustrates a view in perspective of a planting element comprising a flexible transmission device according to the invention.

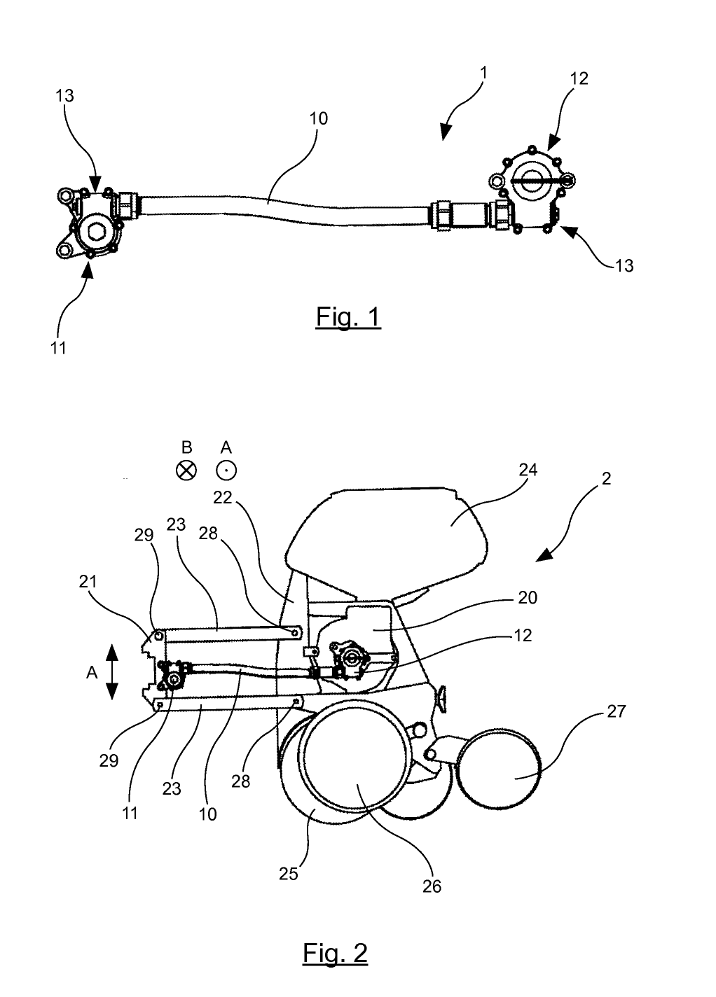

### DESCRIPTION OF ONE EMBODIMENT OF THE INVENTION

### 1. Reminder of the General Principle of the Invention

The general principle of the invention relies on the implementing of means to rigidify the sheath of a flexible transmission along a first direction perpendicular to its longitudinal axis and not, or at any rate to a lesser extent, along a second direction perpendicular to the first direction and to this axis.

The movements of a flexible transmission sheath are thus controlled when the distance between its ends varies.

When a flexible transmission device according to the invention is mounted on an implement, for example a farming implement such as a planting element, it can thus be placed in such a way that the sheath does not rub against the parts of the planting element and/or the implements mounted around it so as to prevent it from being getting worn out.

### 2. Example of a Flexible Transmission Device According to the Invention

### 2.1. Architecture

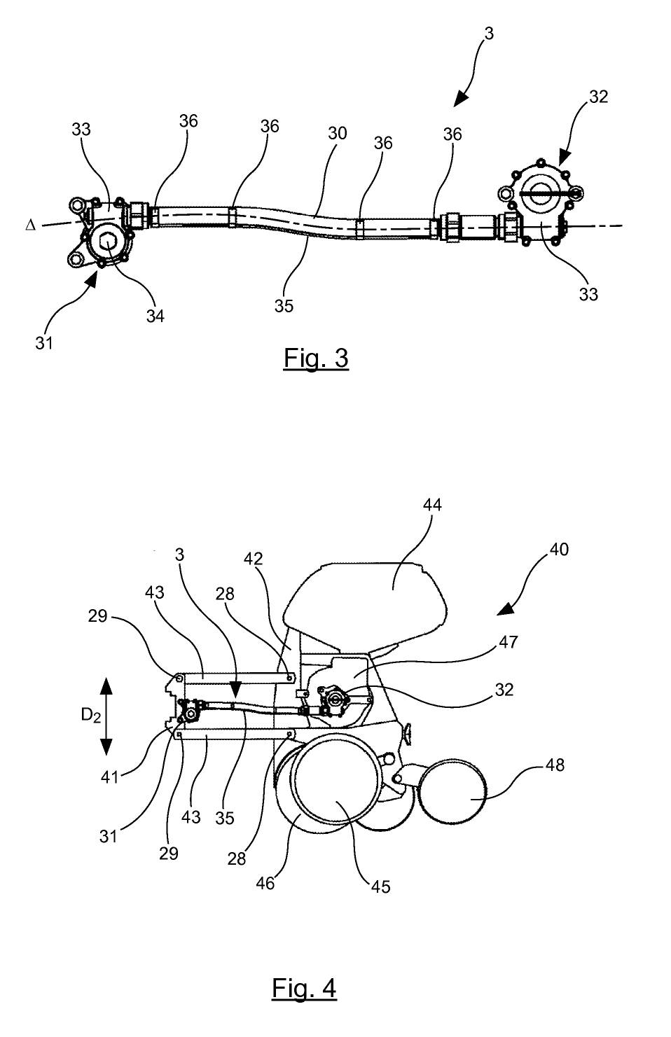

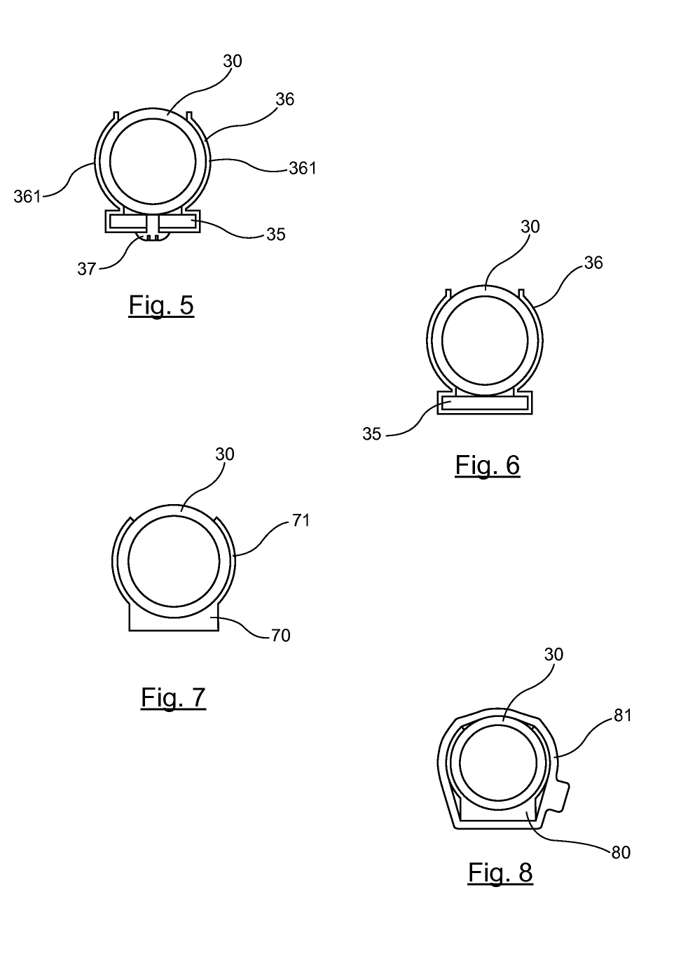

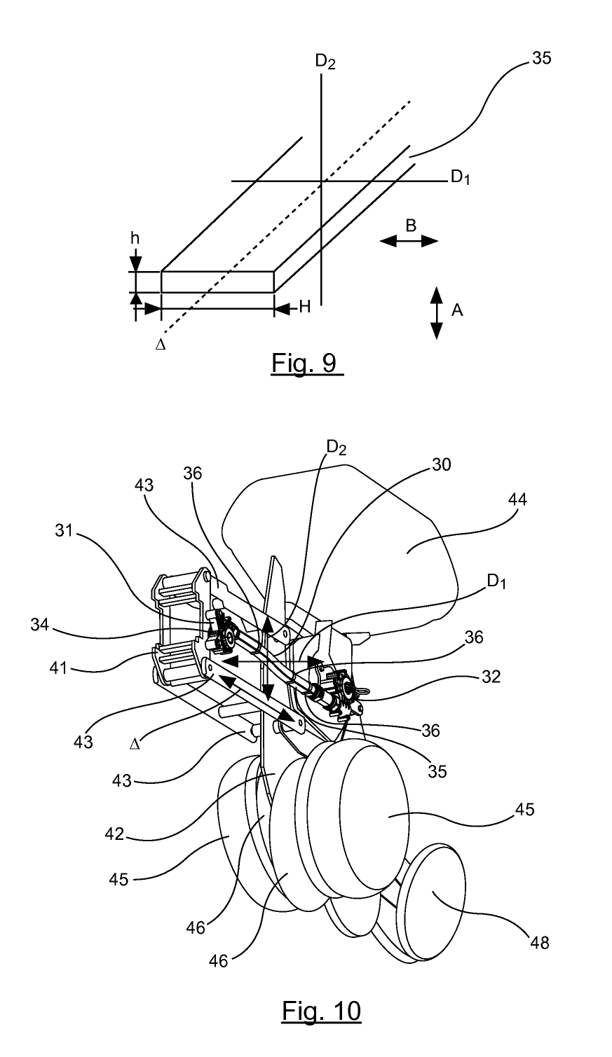

Referring to FIGS. 3 and 5, an embodiment of a flexible transmission device according to the invention is presented.

As shown in FIGS. 3 and 5, a flexible transmission device 3 of this kind comprises a guiding sheath 30 within which a transmission cable (not shown) is mounted. Each end of the transmission cable is respectively connected to a transmission input 31 and a transmission output 32 by means of an angle gear 33.

The transmission input 31 is meant to be connected to a drive means such as for example a driveshaft. It therefore comprises a recess 34 having a shape complementary to that of the driveshaft. In variants, the shape of the input 31 could be different. It could also be connected to another type of drive means.

The rotational motion of the driveshaft which drives the input 31 and more particularly the recess 34 is thus transmitted through the transmission cable and the angle gears 33 to the output 32.

The output 32 is to be connected to an element that has to be driven rotationally. This could for example be the distribution element of the distributor of a planting element.

The flexible transmission device comprises rigidifying means to limit the deformation of the sheath 30 along a first direction D1 perpendicular to the longitudinal axis Δ of the sheath 30 without preventing, or at least in limiting to a lesser extent, the deformation of this sheath along a second direction D2 which is essentially orthogonal to the first direction D1 and to the longitudinal axis Δ.

In this embodiment, these rigidifying means comprise a flat iron strip 35 having a rectangular section.

The height H of the element for rigidifying 35 along the first direction D1 is greater than its height h along the second direction D2. The quadratic moment of the element for rigidifying 35 relative to the direction D2, which is equal to (h*H³)/12, is therefore greater than its quadratic moment relative to the direction D1 which is equal to (H*h³)/12. Thus, the element for rigidifying is more difficult to deform along the direction D1 than along the direction D2. In other words, the element for rigidifying is easier to deform around the direction D1 than around the direction D2.

Metallic clip-on collars 36 are fixedly attached to the element for rigidifying 35, for example by means of screws 37, as shown in FIG. 5, or by press-fitting as shown in FIG. 6.

In one variant, as shown in FIG. 7, the collars 71 and the element for rigidifying 70 could be formed as a single piece.

The element for rigidifying 35 and/or the collars 36 could be made out of plastic.

Each collar 36 comprises two fins 361 which are elastically deformable and define a housing capable of housing the sheath 30. During the fixed joining of the element for rigidifying 35 to a sheath 30, this element 35 is applied against the sheath 30. The fins 361 then move aside gradually so that the sheath 30 can enter into the housing. They then close gradually to keep the sheath 30 imprisoned within the housing.

In the variant illustrated in FIG. 8, the element for rigidifying 80 is fixedly attached to the sheath 30 by means of Serflex® type collars 81.

In other variants, the sheath 30 could be over-molded around the element for rigidifying 35. In this case, as an alternative, it could be made of metal or plastic.

In this embodiment, the element for rigidifying extends all along the sheath. In certain variants, it could extend along only one portion of the sheath. The elements for rigidifying could also include a plurality of elements for rigidifying placed along the sheath.

### 2.2. Controlled Deformation

The fixed attachment of an element for rigidifying according to the invention to a sheath of a flexible transmission enables control over the deformation of the sheath when the distance between its ends varies.

Indeed, the quadratic moment of the element for rigidifying relative to the direction D2 is greater than the quadratic moment relative to the direction D1. In other words, the element for rigidifying withstands bending forces to a greater extent around the direction D2 than around the direction D1. Consequently, when the distance between the ends of the sheath varies, and especially when it is diminished, the sheath gets deformed to a greater extent in the direction D2 than in the direction D1. In other words, the sheath gets deformed to a greater extent along the second direction D2 and around the first direction D1, i.e. in a plane passing through the longitudinal axis Δ and the second direction D2, than along the first direction D1 and around the second direction D2, i.e. along a plane passing through the longitudinal axis Δ and the first direction D1. The deformation of the sheath is in this sense controlled.

### 2.3. Implementation Within a Planting Element

A transmission device according to the invention can for example be implemented within a planting element such as the one shown in FIG. 4.

The planting element 40 comprises a first planting element part 41 and a second planting element part 42. The first planting element part 41 is to be fixedly attached to a frame to which several planting elements can be fixedly attached to form a planter. This frame is itself meant to be fixedly attached to a farm machine (not shown) such as for example a tractor. The first planting element part 41 and second planting element part 42 are fixedly attached to one another by means of two pairs of rods 43 which, with the first planting element part 41 and second planting element part 42, define two deformable hinged parallelograms. The planting element rests on the ground by means of two gauge wheels 45 between which a pair of disk openers 46 is placed. The disk openers 46 are used to open out a furrow in the earth when the planting element 40 is shifted on the ground. The depth of this furrow is adjusted by the position of the gauging wheels 45. The second part of the planting unit 42 supports a seed storage reservoir 44, the outlet of which is connected to a seed distributor 47. The distributor 47 comprises a rotationally mobile distribution unit which is connected to the output 32 of the flexible transmission device 3. The input 31 is meant to be fixedly attached to a driveshaft provided for this purpose. To this end, the driveshaft is introduced into the recess of complementary shape 34. A rotation of this driveshaft rotationally drives the distribution element through the flexible transmission device and thus distributes the seeds contained in the reservoir into the furrow which the disk openers 46 have opened out previously in the cultivatable surface on which the planting element is shifted. A rear block 48, comprising two wheels placed beside each other, closes up the furrow after the seeds have been placed therein.

When the planting element is shifted on the ground, the second part of the planting element unit 42 moves in an essentially vertical plane relative to the first planting element part 41 in following the uneven features of the ground through the use of the hinged rods 43. To enable this movement, the sheath 30 of the flexible transmission device 3 gets deformed.

In the case illustrated in FIG. 4, it is desired that the sheath should get deformed between the two rods 43 essentially along the direction D2 which in this case is substantially vertical. The space made between the two rods 43 is indeed great enough to prevent the sheath 30 from rubbing against them when the planting element is shifted on the ground. However, it is desired that the sheath should get slightly deformed along the direction D1, essentially perpendicularly to the direction D2, and to the longitudinal axis Δ of the sheath 30 which is therefore in this case substantially horizontal. Indeed, it is desired to prevent the sheath 30 from rubbing against the various apparatuses (not shown) that are liable to be placed on either side of the sheath 30.

To this end, the element for rigidifying 35 is fixedly attached to the sheath 30 so that its quadratic moment relative to the direction D1 is smaller than its quadratic moment relative to the direction D2. The sheath 30 then tends to get deformed to a greater extent in a plane passing through the second direction D2 and its longitudinal axis Δ, than in a plane passing through the first direction D1 and its longitudinal axis Δ.

The technique of the invention thus limits wear and tear of the sheath 30 by controlling the directions of deformation to prevent it from rubbing against the elements placed in proximity to itself.

In variants, it can be that the first direction is not horizontal. The orientation of the second direction will be determined accordingly.

An embodiment of the invention provides a flexible transmission device which is particularly robust, and has a relatively lengthy service life, at least as compared with the prior-art transmission systems.

An embodiment of the invention implements a flexible transmission device of this kind which enables control, at least partially, over the deformation of the guiding sheath when the distance between its two ends varies.

An embodiment of the invention procures a device of this kind which is simple to implement.

An embodiment of the invention provides a device of this kind which is simple to make and/or reliable and/or low in cost.

Although the present disclosure has been described with reference to one or more examples, workers skilled in the art will recognize that changes may be made in form and detail without departing from the scope of the disclosure and/or the appended claims.

1. A flexible transmission device comprising:
a guiding sheath housing a transmission cable;
a rigid element configured to limit deformation of said sheath along a first direction perpendicular to a longitudinal axis of said sheath without preventing its deformation along a second direction that is essentially orthogonal to said first direction and to said longitudinal axis, the rigid element being fixedly attached to the sheath.

2. The flexible transmission device according to claim 1, wherein said rigid element comprises at least one element which extends along at least one part of said sheath along the longitudinal axis, the quadratic moment of said at least one rigid element relative to said first direction being smaller than its quadratic moment relative to said second direction.

3. The flexible transmission device according to claim 2, wherein said at least one rigid element has an essentially rectangular section.

4. The flexible transmission device according to claim 2, wherein said at least one rigid element is made out of a metallic material.

5. The flexible transmission device according to claim 4, wherein said at least one rigid element comprises at least one flat iron.

6. The flexible transmission device according to claim 2, wherein said at least one rigid element is made out of at least one of a plastic or composite material.

7. The flexible transmission device according to claim 2, wherein said at least one rigid element is fixedly attached to said sheath by being clipped on.

8. The flexible transmission device according to claim 2, wherein said sheath is over-molded around said at least one rigid element.

9. A rigid element configured to limit deformation of a guiding sheath along a first direction perpendicular to a longitudinal axis of said sheath without preventing deformation of the guiding sheath along a second direction that is essentially orthogonal to said first direction and to said longitudinal axis, the rigid element being configured to be fixedly attached to the sheath.

10. A farming implement comprising:
a flexible transmission device comprising:
a guiding sheath housing a transmission cable; and
a rigid element configured to limit deformation of said sheath along a first direction perpendicular to a longitudinal axis of said sheath without preventing its deformation along a second direction that is essentially orthogonal to said first direction and to said longitudinal axis, the rigid element being fixedly attached to the sheath; and
a first element configured to be fixedly attached to a farming machine, and a second element carrying means for distributing a product that are to be driven in motion by said transmission device, said first and second elements being linked to each other by rods forming, with said elements, at least one parallelogram hinged so that said second element is mobile relative to said first element in a plane passing through said longitudinal axis and said second direction, and wherein one end of said sheath is connected to said means of distribution, and another end of said sheath is fixedly attached to said first element and configured to be fixedly attached to a driving element.
